(19) United States
(12) Patent Application Publication
(10) Pub. No.: US 2024/0342938 A1
(43) Pub. Date: Oct. 17, 2024

(54) SHAVER HANDLE

(71) Applicant: BIC Violex Single Member S.A., Anoixi (GR)

(72) Inventor: Nikolaos CHATZIGRIGORIOU, Anoixi (GR)

(73) Assignee: BIC Violex Single Member S.A., Anoixi (GR)

(21) Appl. No.: 18/575,117

(22) PCT Filed: Jun. 27, 2022
(86) PCT No.: PCT/EP2022/067528

§ 371 Date: Dec. 28, 2023

(30) Foreign Application Priority Data
Jun. 30, 2021 (EP) 21182714.2

(51) Int. Cl. B26B 21/52

(52) U.S. Cl. CPC B26B 21/528

(57) ABSTRACT

The present disclosure relates to a shaver handle, wherein at least part of the shaver handle's surface comprises a first material. The first material comprises a first polymer and rubber particles. The rubber particles comprise carbon black. The core of the shaver handle comprises a second material.

### CROSS REFERENCE TO RELATED APPLICATION

This is a National Stage application under 35 U.S.C. § 371 of International Application No. PCT/EP2022/067528, filed on Jun. 27, 2022, now published as WO 2023/274935 A1, which claims priority to European Patent Application No. 21182714.2, filed on Jun. 30, 2021, the entireties of which are incorporated herein by reference.

### TECHNICAL FIELD

The present disclosure relates to the field of shavers. More specifically, the present disclosure relates to shaver handles, comprising rubber particles.

### BACKGROUND

Razors commonly comprise a shaver handle to provide an ergonomic grip for controlling the razor. The shaver handle may be made at least in part of a polymer.

Razors and their shaver handles may come into contact with water during use. For example, the blade or razor cartridge may be cleaned from shaving debris, such as cut hair and shaving foam, during the shaving procedure. Further, razors comprising razor cartridges with solid soap compositions may be wetted with water to emulsify the solid soap composition. Some razors are also designed to be used in the shower and may therefore be exposed to a constant stream of water.

However, shaver handles may become slippery when wet. In particular, shaver handles made from rigid polymers or metals may have a low coefficient of friction when wet. As a result, they may feel slippery to the use and not provide the desired amount of control. Recently, thermoplastic elastomers have been used in shaver handles. The thermoplastic elastomers may increase the shaver handle's coefficient of friction, in particular when wet. However, the thermoplastic elastomers may feel sticky for the user which may be unpleasant.

The present disclosure aims to address one or more problems in the prior art.

### SUMMARY

In a first aspect, the present disclosure relates to a shaver handle, wherein at least part of the shaver handle's surface comprises a first material, wherein the first material comprises a first polymer and rubber particles, wherein the rubber particles comprise carbon black and wherein the core of the shaver handle comprises a second material.

In some embodiments, the rubber particles may be devulcanized rubber particles, in particular surface-devulcanized rubber particles.

In some embodiments, a surface layer of the rubber particles may comprise functional groups, in particular hydroxyl-groups, epoxy-groups, thiol-groups and/or carboxyl-groups.

In some embodiments, the surface layer of the rubber particles may comprise a higher concentration of the functional groups compared to the bulk of the rubber particles.

In some embodiments, the surface layer of the rubber particles may comprise disulfide moieties in a lower concentration compared to the bulk of the rubber particles.

In some embodiments, the first polymer and the rubber particles may be compatible or may be present as compatibilized blend.

In some embodiments, the first polymer and the rubber particles are linked, in particular by covalent bonds.

In some embodiments, the carbon black may be dispersed within the rubber particles.

In some embodiments, the rubber particles may have an average particle size of between about 10 μm to about 2000 μm, more specifically between about 50 μm to about 1500 μm and in particular between about 150 μm to about 850 μm.

In some embodiments, the first polymer may be a thermoplastic elastomer.

In some embodiments, the thermoplastic elastomer may be a styrenic block copolymer, in particular styrene-ethylene-butylene-styrene.

In some embodiments, the first material may comprise between about 5 wt.-% and about 60 wt.-%, more specifically between about 10 wt.-% and about 45 wt.-% and in particular between about 15 wt.-% and about 30 wt.-% of the rubber particles, relative to the total weight of the first material.

In some embodiments, the first material may comprise between about 40 wt.-% and about 90 wt.-%, more specifically between about 50 wt.-% and about 80 wt.-% and in particular between about 55 wt. % and about 70 wt. % first polymer, relative to the total weight of the first material.

In some embodiments, the rubber particles may comprise between about 5 wt.-% and about 60 wt.-%, more specifically between about 7 wt.-% and about 40 wt.-% and in particular between about 10 wt.-% and about 20 wt.-% carbon black, relative to the total weight of the rubber particles.

In some embodiments, the rubber particles may be recycled from tires, in particular recycled from automotive tires.

In some embodiments, the rubber particles may comprise natural and/or synthetic rubber and in particular mixtures thereof.

In some embodiments, the ratio of synthetic and natural rubber may be between about 6:1 to about 1:1, more specifically between about 5:1 to about 1.5:1 and in particular between about 4:1 to about 2:1.

In some embodiments, the ratio of synthetic and natural rubber may be between about 3:1 to about 1:3, more specifically between about 2:1 to about 1:2 and in particular between about 1.5:1 to about 1:1.5.

In some embodiments, the rubber particles may comprise poly-cis-isoprene, styrene-butadiene rubber, copolymer of isobutylene with isoprene (butyl rubber), polyisoprene, chloroprene or nitrile rubber, or mixtures thereof.

In some embodiments, the rubber particles may comprise poly-cis-isoprene and styrene-butadiene rubber.

In some embodiments, the rubber particles may comprise styrene-butadiene rubber.

In some embodiments, the carbon black may have an average particle size of between about 10 nm to about 45 nm, more specifically between about 15 nm to about 40 nm and in particular between about 20 nm to about 35 nm.

In some embodiments, the rubber particles may comprise fillers, in particular silica, chalk or mixtures thereof.

In some embodiments, the rubber particles may comprise between about 5 wt.-% and about 50 wt.-%, more specifically between about 10 wt.-% and about 40 wt.-% and in particular between about 20 wt.-% and about 35 wt.-% of a mixture of fillers and carbon black, relative to the total weight of the rubber particles.

In some embodiments, the shaver rubber particles may comprise vulcanization agents, in particular sulfur and/or zinc oxide.

In some embodiments, the rubber particles may comprise between about 1 wt.-% and about 10 wt.-%, more specifically between about 2 wt.-% and about 8 wt.-% and in particular between about 3 wt.-% and about 7 wt.-% of vulcanization agents, relative to the total weight of the rubber particles.

In some embodiments, the rubber particles may comprise plasticizers.

In some embodiments, the rubber particles may comprise between about 5 wt.-% and about 20 wt.-%, more specifically between about 7 wt.-% and about 18 wt.-% and in particular between about 10 wt.-% and about 15 wt.-% of plasticizers, relative to the total weight of the rubber particles.

In some embodiments, the rubber particles may comprise antioxidants and antiozonants.

In some embodiments, the rubber particles may comprise between about 0.1 wt.-% and about 5 wt.-%, more specifically between about 0.5 wt.-% and about 3 wt.-% and in particular between about 0.8 wt.-% and about 2.0 wt.-% of a mixture of antioxidants and antiozonants, relative to the total weight of the rubber particles.

In some embodiments, the coefficient of friction of the first material in dry condition may be between about 0.45 mN and about 0.7 mN, more specifically between about 0.5 mN and about 0.65 mN and in particular between about 0.54 mN and about 0.6 mN.

In some embodiments, the coefficient of friction of the first material in wet condition may be between about 0.5 mN and about 1.1 mN, more specifically between about 0.55 mN and about 1.05 mN and in particular between about 0.6 mN and about 1.0 mN.

In some embodiments, the second material may comprise a second polymer.

In some embodiments, the second material may comprise a thermoplastic polymer, more specifically a polyolefin and in particular a polypropylene.

In some embodiments, the second material may comprise a filler, in particular CaCO₃ and/or talc.

In some embodiments, the second material may comprise between about 5 wt.-% to about 40 wt.-%, more specifically between about 10 wt.-% to about 35 wt.-% and in particular between about 15 wt.-% to about 30 wt % of the filler or mixture of fillers, relative to the total weight of the polymer.

In some embodiments, the shaver handle may comprise an odor scavenger and/or a fragrance.

According to a second aspect the present disclosure relates to a process for manufacturing a shaver handle, wherein the process comprises injection molding or extruding a blank comprising the second material, and overmolding the blank with the first material.

In a third aspect the present disclosure relates to a process for manufacturing a shaver handle, wherein the process comprises co-extruding the first and second material such that the second material forms an inner body and the first material at least partially encloses the inner body.

In some embodiments, the first material comprises a first polymer and rubber particles, wherein the rubber particles comprise carbon black.

In some embodiments, the rubber particles are recycled from tires, in particular recycled from automotive tires.

### BRIEF DESCRIPTION OF THE DRAWINGS

FIG. 1 Razor comprising a razor cartridge and shaver handle

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

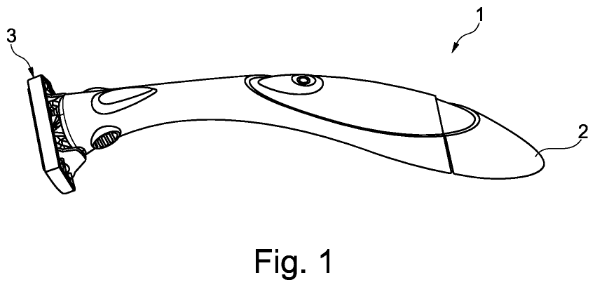

FIG. 1 shows a razor (1) comprising a razor cartridge (3) and a shaver handle (2). Razors (1) typically comprise shaver handles (2) to control the razor (1) during the shaving action. Shaver handles (2) of razors (1) may feel slippery when wet, as they may have a low coefficient of friction when wet. Thermoplastic elastomers may be used to increase the coefficient of friction of shaver handles (2) when they are wet, thereby increasing the controllability of the razor (1). However, shaver handles (2) comprising surfaces primarily composed of thermoplastic elastomers may have increased tack, in particular when dry. A typical thermoplastic elastomer for this purpose is Bergaflex BFI G 40A-3E1719 natural. The term “tack” within this disclosure refers to a material characteristic wherein the material forms an immediate cohesive adherence to a contacting surface. Materials with high tack may feel sticky to the user. Stickiness may be an undesirable haptic feeling for the user. Hence, a lower tack may provide the user with an improved haptic feeling.

It has been surprisingly found that a polymer comprising rubber particles may provide a surface with an improved coefficient of friction. Further, the surface of a polymer comprising rubber particles may exhibit a low tack. Additionally, it has been surprisingly found that adding carbon black to the rubber particles may result in an increased lifetime of the shaving handle.

Accordingly, in a first aspect, the present disclosure relates to a shaver handle (2), wherein at least part of the shaver handle's (2) surface comprises a first material, wherein the first material comprises a first polymer and rubber particles, wherein the rubber particles comprise carbon black and wherein the core of the shaver handle (2) comprises a second material.

Carbon black may increase the wear resistance of the rubber particles. As the shaving handle may undergo abrasion in use, an increased wear resistance of the rubber particles may reduce the material loss of the rubber particles. Reduced material loss of the rubber particles may increase the lifetime of the shaving handle. Further, the carbon black may absorb ultraviolet radiation. Ultraviolet radiation may degrade materials, in particular polymers. As a result, rubber particles comprising carbon black may reduce material degradation by ultraviolet radiation.

A core comprising a second material may be advantageous to provide a shaver handle (2) with improved mechanical properties. The first material may exhibit a low elastic modulus. As a result, the first material may deform easily under stress. A material that deforms easily under stress may deform during the shaving action which may lead to a less controllable shaving action. A less controllable shaving action may be undesirable by the user or may even lead to cuts into the skin. A core comprising a second material, in particular a second material with a high modulus of elasticity, may provide a shaver handle (2) with improved resistance to deformation.

Further, the second material may be cheaper compared to the first material. Hence, the use of a second material may reduce the production costs.

In some embodiments, the rubber particles may be devulcanized rubber particles, in particular surface-devulcanized rubber particles.

The term “rubber particles” within this disclosure refers to particles made of a rubber material. The term “rubber material” within this disclosure refers to thermoset elastomers, in particular thermoset elastomers comprising disulfide bonds.

Disulfide bonds may be introduced to rubber materials or their precursors by vulcanization. The term “vulcanization” is well known in the art and refers to a range processes for hardening rubbers, in particular by the introduction of sulfur to form disulfide bonds. These disulfide bonds may cross-link adjacent polymer chains or regions of the same polymer chain. The cross-linking of the polymer chains may modify the properties of the polymer comprising the polymer chains. The cross-linking may increase the rubber material's rigidity and durability. Further, vulcanization may improve the elastic properties of the rubber, e.g. increase the yield point.

The term “devulcanization” within this disclosure shall refer to a process wherein sulfur bonds are cleaved within a rubber material. The sulfur bonds may be cleaved by chemical, thermophysical, ultrasonic-based, microwave-assisted or biological means. “Devulcanized rubber particles” or “surface-devulcanized rubber particles” are rubber particles that have undergone a devulcanization process. Devulcanized rubber particles may have undergone devulcanization at any location of the rubber particle. Surface-devulcanized rubber particles must have undergone a devulcanization process, wherein more sulfur bonds have been broken up at a surface layer of the rubber particles compared to the bulk of the particle. The cleaving of the sulfur-bonds may lead to formation of functional groups, in particular the formation of functional groups in place of the disulfide bonds.

Devulcanized rubber particles or surface-devulcanized rubber particles may be attained by first grinding a rubber material comprising sulfur bonds to obtain rubber particles. In some embodiments, the rubber material may be obtained from new or used car tires. The utilization of used car tires may be advantageous for recycling the material, and thus for saving resources. After grinding the rubber particles may undergo a devulcanization process to obtain devulcanized rubber particles or surface-devulcanized rubber particles.

In some embodiments, the devulcanization process and in particular the surface devulcanization may be performed by the biological method as described in EP319769B1, the content being incorporated herein by reference.

In some embodiments, a surface layer of the rubber particles may comprise functional groups, in particular hydroxyl-groups, epoxy-groups, thiol-groups and/or carboxyl-groups.

In some embodiments, the surface layer of the rubber particles may comprise a higher concentration of the functional groups compared to the bulk of the rubber particles. The term “surface layer of the rubber particles” within this disclosure refers to the layer of the rubber particles that form the interface with the surrounding matter. In particular, the surface layer may be seen as the outermost layer of the particles with a thickness of e.g. about 1 μm. A higher concentration of functional groups in the surface layer compared to the bulk of the particles may provide improved adhesion between the rubber particles and the first polymer. An increased concentration of functional groups in the surface layer may lead to stronger intermolecular forces, for example hydrogen bonds, between the first polymer and the rubber particles. The stronger intermolecular forces may lead to a stronger adhesion. Further, some of the functional groups may react with parts of the first polymer resulting in covalent bonds. The covalent bonds may also increase the adhesion between the first material and the rubber particles. A stronger adhesion between the first material and the rubber particles may reduce the loss of rubber particles. A loss of rubber particles may lead to a decreased coefficient of friction of the shaver handle (2) when dry and/or wet.

In some embodiments, the surface layer of the rubber particles may comprise disulfide moieties in a lower concentration compared to the bulk of the rubber particles. The devulcanization process may lead to a reduction of the disulfide moieties within the surface of the rubber particles compared to the bulk of the rubber particles.

In some embodiments, the concentration of functional groups may be measured by Fourier-transform infrared spectroscopy, with an Alpha II Compact FT-IR Spectrometer sold by the company Bruker Corp. In some embodiments, the concentration of disulfide moieties may be measured by scanning-electron-microscopy coupled with an energy-dispersive X-ray analysis system, with a Tabletop Microscope TM4000ll sold by the company K.K. Hitachi Seisakusho.

In some embodiments, the first polymer and the rubber particles may be compatible or may be present as compatibilized blend. The term “compatibility” within this disclosure is not particularly limited and i.a. refers to its common meaning in the art, e.g. as established in Jan W. Gooch (ed.), Encyclopedic Dictionary of Polymers, 2007, page 214, entry “Compatibility”. Additionally or alternatively, the term may refer to an increased adhesion at interfaces of two polymers compared to adhesion relying solely on van der Waals forces. Compatibility between the first polymer and the rubber particles may prevent or reduce the phase segregation and/or liberation of the rubber particles from the first polymer, as the adhesive forces are increased. Liberation of the rubber particles from the polymer may lead to a loss of rubber particles from the shaver handle (2) which in turn may lead to a reduction of the coefficient of friction of the shaver handle surface. The first polymer and rubber particles may not have sufficient compatibility by themselves. In some embodiments, the first material may comprise a compatibilizer. The term “compatibilizer” is intended to have its common meaning in the art, e.g. as established in Jan W. Gooch (ed.), Encyclopedic Dictionary of Polymers, 2007, page 214, entry “Compatibilizer”. The compatibilizer may be a reactive or non-reactive compatibilizer. In particular, the compatibilizer may be an organofunctional silane.

In some embodiments, the first polymer and the rubber particles are linked, in particular by covalent bonds. Linking the rubber particles to the first polymer, in particular by covalent bonds, may prevent or reduce the liberation of the rubber particles from the first polymer, as the linking may bind the rubber particles to the first polymer. Liberation of the rubber particles from the polymer may lead to a loss of rubber particles from the shaver handle (2) which may lead to a reduction of the coefficient of friction of the shaver handle surface. The linking may be in particular by a cross-link. The term “cross-link” within this disclosure shall refer to a covalent or ionic bond that links one polymer chain to another polymer chain.

In some embodiments, the carbon black may be dispersed within the rubber particles. The term “dispersed” within this disclosure shall refer to a state wherein particles of one material are substantially randomly distributed within a continuous phase of another material. The dispersion may provide rubber particles with uniform abrasion resistance.

In some embodiments, the rubber particles may have an average particle size of between about 10 μm to about 2000 μm, more specifically between about 50 μm to about 1500 μm and in particular between about 150 μm to about 850 μm. Rubber particles of this size may provide a high coefficient of wear. Further, rubber particles of this size comprised within the first material may provide a substantially uniform distribution of the coefficient of wear to the first material.

In some embodiments, the first polymer may be a thermoplastic elastomer. Thermoplastic elastomers may provide the shaving handle with an increased coefficient of friction when dry and/or wet, compared to for example rigid thermoplastic or thermoset polymers. Furthermore, thermoplastic elastomers may be easier to process compared to thermosetting polymers, as they can be molten. This may allow dispersing the rubber particles within the first polymer prior to further processing. In some embodiments, a shaver handle blank may be manufactured by injection molding or extrusion, wherein the rubber particles are dispersed within the thermoplastic polymer prior to the manufacturing process.

In some embodiments, the thermoplastic elastomer may be a styrenic block copolymer, in particular styrene-ethylene-butylene-styrene.

In some embodiments, the first material may comprise between about 5 wt.-% and about 60 wt.-%, more specifically between about 10 wt.-% and about 45 wt.-% and in particular between about 15 wt.-% and about 30 wt.-% of the rubber particles, relative to the total weight of the first material. A lower content of rubber particles in the first material may lead to a first material with a lower coefficient of friction. A higher content of rubber particles in the first material may lead to a reduced cohesion of the first material. A reduced cohesion of the first material may lead to breakage of the first material under mechanical stress, e.g. during the shaving action.

In some embodiments, the first material may comprise between about 40 wt.-% and about 90 wt.-%, more specifically between about 50 wt.-% and about 80 wt.-% and in particular between about 55 wt. % and about 70 wt. % first polymer, relative to the total weight of the first material. A higher content of first polymer may lead to a first material with increased tack. A lower content of first polymer in the first material may lead to a reduced cohesion of the first material. A reduced cohesion of the first material may lead to breakage of the first material under mechanical stress, e.g. during the shaving action.

The first material may comprise additives, e.g. fillers, plasticizers and/or antioxidants.

In some embodiments, the rubber particles may comprise between about 5 wt.-% and about 60 wt.-%, more specifically between about 7 wt.-% and about 40 wt.-% and in particular between about 10 wt.-% and about 20 wt.-% carbon black, relative to the total weight of the rubber particles. The carbon black may add to the abrasion resistance of the rubber particles. The increased abrasion resistance may reduce the wear of the rubber particles during use. Hence, increased abrasion resistance of the rubber particles may increase the longevity of the shaver handle (2). A lower content of carbon black in the rubber particles may result in rubber particles with lower abrasion resistance. A higher content of carbon black in the rubber particles may result in a reduced cohesion of the rubber particles. A reduced cohesion of the rubber particles may lead to breakage of the rubber particles under mechanical stress.

In some embodiments, the rubber particles may be recycled from tires, in particular recycled from automotive tires. The utilization of used tires may be advantageous to save resources. The tires may be cut to separate the rubber material from other components, e.g. from steel treads. The rubber material may then be ground to obtain rubber particles. The rubber particles obtained from the tires may undergo a devulcanization process to obtain devulcanized and/or surface-devulcanized rubber particles.

In some embodiments, the rubber particles may comprise natural and/or synthetic rubber and in particular mixtures thereof.

In some embodiments, the ratio of synthetic and natural rubber may be between about 6:1 to about 1:1, more specifically between about 5:1 to about 1.5:1 and in particular between about 4:1 to about 2:1.

In some embodiments, the ratio of synthetic and natural rubber may be between about 3:1 to about 1:3, more specifically between about 2:1 to about 1:2 and in particular between about 1.5:1 to about 1:1.5. Mixing natural and synthetic rubber may result in rubber particles with good mechanical properties, such as yield strength. Increasing the proportion of synthetic rubber may reduce the cost of the material. Increasing the proportion of natural rubber may improve the mechanical properties as natural rubber may strain crystallize. Strain crystallization may increase the materials toughness and ultimate tensile stress. On the other hand, natural rubber may be more prone to degradation by ozone compared to synthetic rubber.

In some embodiments, the rubber particles may comprise poly-cis-isoprene, styrene-butadiene rubber, copolymer of isobutylene with isoprene (butyl rubber), polyisoprene, chloroprene or nitrile rubber, or mixtures thereof.

In some embodiments, the rubber particles may comprise poly-cis-isoprene and styrene-butadiene rubber.

In some embodiments, the rubber particles may comprise styrene-butadiene rubber.

In some embodiments, the carbon black may have an average particle size of between about 10 nm to about 45 nm, more specifically between about 15 nm to about 40 nm and in particular between about 20 nm to about 35 nm. Smaller particle sizes may be expensive to produce, whereas bigger particles sizes may not provide a sufficient abrasion resistance.

In some embodiments, the rubber particles may comprise fillers, in particular silica, chalk or mixtures thereof. The use of fillers may reduce the material price and/or improve the mechanical properties, e.g. yield strength. However, a high amount of fillers may also deteriorate the mechanical properties.

In some embodiments, the rubber particles may comprise between about 5 wt.-% and about 50 wt.-%, more specifically between about 10 wt.-% and about 40 wt.-% and in particular between about 20 wt.-% and about 35 wt.-% of a mixture of fillers and carbon black, relative to the total weight of the rubber particles.

In some embodiments, the shaver rubber particles may comprise vulcanization agents, in particular sulfur and/or zinc oxide. The vulcanization agents may improve the vulcanization reaction which may be required to form the rubber material of the rubber particles. The sulfur may form disulfide bonds. The zinc oxide may be a catalyst for the disulfide bond formation.

In some embodiments, the rubber particles may comprise between about 1 wt.-% and about 10 wt.-%, more specifically between about 2 wt.-% and about 8 wt.-% and in particular between about 3 wt.-% and about 7 wt.-% of vulcanization agents, relative to the total weight of the rubber particles. The amount of vulcanization agent may influence the rubber material properties. A higher amount of vulcanization agent may increase the rigidity and durability of the rubber material and hence the durability of the rubber particles. However, a high rigidity may reduce the interaction between the hand of a user and the rubber particles and therefore may not provide a sufficiently high coefficient of friction. A lower amount of vulcanization agents may lead to a lower durability and hence a lower lifetime of the rubber particles. A balanced amount of vulcanization agents may be required to achieve balanced properties of the rubber particles.

In some embodiments, the rubber particles may comprise plasticizers. Plasticizers are substances added to materials to make them softer, more flexible and/or increase the materials plasticity.

In some embodiments, the rubber particles may comprise between about 5 wt.-% and about 20 wt.-%, more specifically between about 7 wt.-% and about 18 wt.-% and in particular between about 10 wt.-% and about 15 wt.-% of plasticizers, relative to the total weight of the rubber particles. Plasticizers may reduce the elastic modulus of the rubber particles. A lower elastic modulus of the rubber particles may lead to the rubber particles being more pliable. An increase of pliability may result in a higher interface area between a hand holding the shaver and the rubber particles. A higher interface area may lead to a higher coefficient of friction. The plasticizer may comprise one or more of polyolefin oils, naphthenic oils, paraffinic oils, vegetable oils, distilled aromatic extracts, residual aromatic extracts, treated distilled aromatic extracts, mild extracted solvents.

In some embodiments, the rubber particles may comprise antioxidants and antiozonants.

In some embodiments, the rubber particles may comprise between about 0.1 wt.-% and about 5 wt.-%, more specifically between about 0.5 wt.-% and about 3 wt.-% and in particular between about 0.8 wt.-% and about 2.0 wt.-% of a mixture of antioxidants and antiozonants, relative to the total weight of the rubber particles. Some antioxidants may also act as antiozonants and vice versa. Antioxidants and antiozonants may slow the degradation of polymers.

Antiozonants may form a protective layer on the rubber particles surface and/or react with the ozone, to protect the rubber material. In some embodiments, antiozonants may be derivatives of p-phenylenediamine (p-PDA). The mixture of antioxidants and antiozonants may comprise isopropyl phenyl-p-phenylenediamine. The antioxidants and antiozonants may also come in the form of prepared masterbatches. For example, MB AO10 sold by the company Plastika Kritis is an antioxidant masterbatch.

Antioxidants may be radical or hydroperoxide scavengers. In some embodiments, the antioxidant may be butylated hydroxytoluene.

In some embodiments, the coefficient of friction of the first material in dry condition may be between about 0.45 mN and about 0.7 mN, more specifically between about 0.5 mN and about 0.65 mN and in particular between about 0.54 mN and about 0.6 mN.

In some embodiments, the coefficient of friction of the first material in wet condition may be between about 0.5 mN and about 1.1 mN, more specifically between about 0.55 mN and about 1.05 mN and in particular between about 0.6 mN and about 1.0 mN.

The friction between two bodies may depend upon the force pressing the two bodies together. The coefficient of friction is a dimensionless scalar value which described the ratio of the force of friction between two bodies and the force pressing them together. As a result, a higher coefficient of friction signifies that less force pressing two bodies together is required to attain the same amount of friction. A high friction between the user's hand and the shaver handle (2) may result in improved razor control by the user. Hence, a higher coefficient of friction may provide the user with improved control over the shaver. A higher coefficient of friction may allow holding the shaving handle with less force to attain the required friction for control. Applying less force to hold the shaving handle may be more comfortable for the user. Further, a shaver handle (2) exhibiting a lower coefficient of friction when dry compared to wet may feel less sticky when dry but provide improved controllability when wet.

For the purpose of this disclosure, the coefficient of friction may be measured by using a tactile measurement device, for example a UST®-Universal Surface Tester sold by the company Innowep GmbH. The UST is a tactile measurement device for the characterization of surface properties.

In regards to measuring the coefficient of friction in dry condition, an exemplary sample preparation and measurement protocol may be as follows:

A shaver handle (2) is used as the sample and fixed below the UST's test tip. For the test tip a standardized leather tip with a radius of curvature of 20 mm is used. The UST comprises a microfriction measurement module. When using the microfriction measurement module the test tip is dragged along the surface of the sample in a straight line under constant load. A force sensor measures the rest force tangential to the sample surface, which corresponds to the friction force between the tip and the sample surface. The length of the straight line is set to 20 mm and the test velocity to 1 mm/s. The average friction force along the straight line is measured by the device and divided by the load to attain a coefficient of friction. The load is varied between 110 mN and 910 mN in steps of 100 mN, leading to 9 measurements overall. The coefficient of friction of the sample is then computed as the average of the coefficients of frictions obtained by the 9 measurements.

To measure the coefficient of friction in wet condition the same protocol as stated above may be used with the following modifications. Prior to the coefficient of friction measurement, the test tip of the UST is immersed in water for 60 minutes. Furthermore, the samples are fixated under water. The used water shall be deionized water, class 3 according to OENORM EN ISO 3696:1995-08-01.

In some embodiments, the second material may comprise a second polymer.

In some embodiments, the second material may comprise a thermoplastic polymer, more specifically a polyolefin and in particular a polypropylene. The second material, in particular polypropylene, may be a cheap material with good mechanical properties. However, the second material, in particular polypropylene, may be prone to degradation by ultraviolet radiation.

In some embodiments, the second material may comprise a filler, in particular CaCO₃ and/or talc.

In some embodiments, the second material may comprise between about 5 wt.-% to about 40 wt.-%, more specifically between about 10 wt.-% to about 35 wt.-% and in particular between about 15 wt. % to about 30 wt.-% of the filler or mixture of fillers, relative to the total weight of the polymer. A second material comprising a filler may have improved mechanical properties, for example increased tensile strength or elastic modulus. Improved mechanical properties of the second material may be advantageous, as the second material may be subjected to forces during the shaving action. Further, the fillers may improve the processing properties of the second material and reduce its price. However, a high amount of fillers may result in a reduction of material cohesion which may lead to material failure.

In some embodiments, the shaver handle (2) may comprise an odor scavenger and/or a fragrance. In some embodiments, the first material may comprise an odor scavenger and/or a fragrance. The materials of the shaver handle (2), in particular the first material, may smell unpleasant. More specifically the rubber particles, in particular rubber particles manufactured from scrap tires, may smell unpleasant. Fragrances may mask unpleasant smells, while odor scavengers may absorb unpleasant smells.

According to a second aspect the present disclosure relates to a process for manufacturing a shaver handle (2), wherein the process comprises injection molding or extruding a blank comprising the second material, and overmolding the blank with the first material, more specifically wherein the first material comprises a first polymer and rubber particles, wherein the rubber particles comprise carbon black. The fragrances and odor scavengers may also come in the form of prepared masterbatches. Examples for fragrances are DE0588, DE0592, Levander 1412 OC and Forest 1411 OC sold by the company Plastika Kritis. In other words, according to a second aspect, the present disclosure relates to a process for manufacturing a shaver handle (2) wherein at least part of the shaver handle's surface comprises a first material, wherein the first material comprises a first polymer and rubber particles, wherein the rubber particles comprise carbon black and wherein the core of the shaver handle comprises a second material, wherein the process comprises injection molding or extruding a blank comprising the second material, and overmolding the blank with the first material.

In the above process, the first material may comprise a first polymer and rubber particles, and the rubber particles may comprise carbon black. In particular, the rubber particles may be recycled from tires, more particularly recycled from automotive tires.

In a third aspect the present disclosure relates to a process for manufacturing a shaver handle (2), wherein the process comprises co-extruding the first and second material such that the second material forms an inner body and the first material at least partially encloses the inner body, more specifically wherein the first material comprises a first polymer and rubber particles, wherein the rubber particles comprise carbon black. Alternatively or additionally, the first material may at least partially surround the inner body after co-extrusion. In other words, according to a third aspect, the present disclosure relates to a process for manufacturing a shaver handle (2) wherein at least part of the shaver handle's surface comprises a first material, wherein the first material comprises a first polymer and rubber particles, wherein the rubber particles comprise carbon black and wherein the core of the shaver handle comprises a second material, wherein the process comprises co-extruding the first and second material such that the second material forms an inner body and the first material at least partially encloses the inner body.

In the above process, the first material may comprise a first polymer and rubber particles, and the rubber particles may comprise carbon black. In particular, the rubber particles may be recycled from tires, more particularly recycled from automotive tires.

### EXAMPLE

A first material with a composition according to Table 1 was prepared. The composition of the rubber particles is shown in Table 2. The first material was then used to manufacture a shaver handle according to the first aspect.

TABLE 1
Composition of first material

| Components | Amount (wt.-%) |
|---|---|
| First Polymer: Styrene-ethylene- | 60 |
| butylene-styrene | |
| Rubber Particles: Surface- | 30 |
| devulcanized rubber particles | |
| Antioxidant: MB AO10 | 2 |
| Fragrance: MB DEO592 | 8 |

TABLE 2
Composition of rubber particles

| Components | Amount (wt.-%) |
|---|---|
| Natural Rubber | 32.0 |
| Copolymer of isobutylene | 32.0 |
| with isoprene | |
| Carbon Black | 15 |
| Sulfur | 2.0 |
| Zinc Oxide | 4 |
| Silica | 5 |
| Paraffinic Oil | 7 |
| Butylated Hydroxytoluene | 1.5 |
| Isopropyl phenyl-p- | 1.5 |
| phenylenediamine | |

The coefficient of friction of example 1 was measured according to the aforementioned protocol, using a universal surface tester sold by the company Innowep GmbH. The measured coefficients of friction were between 0.69 and 0.88 in dry condition. The average coefficient of friction in dry condition was 0.75. The measured coefficients of friction were between 0.76 and 0.83 in wet condition. The average coefficient of friction in wet condition was 0.79. As can be seen above, the composition of example 1 showed an increase of the coefficient of friction in the wet state compared to the dry state.

The measurement was also performed on a shaver handle manufactured from Bergaflex BFI G 40A-3E1719 natural as first material. Bergaflex BFI G 40A-3E1719 natural is a material comprising styrene-ethylene-butylene-styrene. The Bergaflex material did not comprise rubber particles comprising carbon black. The coefficient of friction of the styrene-ethylene-butylene-styrene without rubber particles was measured according to the aforementioned protocol, using a universal surface tester sold by the company Innowep GmbH. The measured coefficients of friction were between 0.45 and 0.59 in dry condition. The average coefficient of friction in dry condition was 0.52. The measured coefficients of friction were between 0.31 and 0.43 in wet condition. The average coefficient of friction in wet condition was 0.37. As can be seen above, the styrene-ethylene-butylene-styrene without rubber particles showed a decrease of the coefficient of friction in the wet state compared to the dry state. Furthermore, the material had a lower coefficient of friction in the dry and wet state compared to the material of example 1.

### Aspects

The present disclosure further relates to the following aspects.

1. A shaver handle, wherein at least part of the shaver handle's surface comprises a first material, wherein the first material comprises a first polymer and rubber particles, wherein the rubber particles comprise carbon black and wherein the core of the shaver handle comprises a second material.

2. The shaver handle according to aspect 1, wherein the rubber particles comprise devulcanized rubber particles, in particular surface-devulcanized rubber particles.

3. The shaver handle according to any preceding aspect, wherein a surface layer of the rubber particles comprises functional groups, in particular hydroxyl-groups, epoxy-groups, thiol-groups and/or carboxyl-groups.

4. The shaver handle according to aspect 3, wherein the surface layer of the rubber particles comprises a higher concentration of the functional groups compared to the bulk of the rubber particles.

5. The shaver handle according to aspect 3 or 4, wherein the surface layer of the rubber particles comprises disulfide moieties in a lower concentration compared to the bulk of the rubber particles.

6. The shaver handle according to any preceding aspect, wherein the first polymer and the rubber particles are compatible or are present as compatibilized blend.

7. The shaver handle according to any preceding aspect, wherein the first polymer and the rubber particles are linked, in particular by covalent bonds.

8. The shaver handle according to any preceding aspect, wherein the carbon black is dispersed within the rubber particles.

9. The shaver handle according to any preceding aspect, wherein the rubber particles have an average particle size of between about 10 μm to about 2000 μm, more specifically between about 50 μm to about 1500 μm and in particular between about 150 μm to about 850 μm.

10. The shaver handle according to any preceding aspect, wherein the first polymer is a thermoplastic elastomer.

11. The shaver handle according to aspect 10, wherein the thermoplastic elastomer is a styrenic block copolymer, in particular styrene-ethylene-butylene-styrene.

12. The shaver handle according to any preceding aspect, wherein the first material comprises between about 5 wt.-% and about 60 wt.-%, more specifically between about 10 wt.-% and about 45 wt.-% and in particular between about 15 wt.-% and about 30 wt.-% of the rubber particles, relative to the total weight of the first material.

13. The shaver handle according to any preceding aspect, wherein the first material comprises between about 40 wt.-% and about 90 wt.-%, more specifically between about 50 wt.-% and about 80 wt.-% and in particular between about 55 wt. % and about 70 wt. % first polymer, relative to the total weight of the first material.

14. The shaver handle according to any preceding aspect, wherein the rubber particles comprise between about 5 wt.-% and about 60 wt.-%, more specifically between about 7 wt.-% and about 40 wt.-% and in particular between about 10 wt.-% and about 20 wt.-% carbon black, relative to the total weight of the rubber particles.

15. The shaver handle according to any preceding aspect, wherein the rubber particles are recycled from tires, in particular recycled from automotive tires.

16. The shaver handle according to any preceding aspect, wherein the rubber particles comprise natural and/or synthetic rubber and in particular mixtures thereof.

17. The shaver handle according to aspect 16, wherein the ratio of synthetic and natural rubber is between about 6:1 to about 1:1, more specifically between about 5:1 to about 1.5:1 and in particular between about 4:1 to about 2:1.

18. The shaver handle according to aspect 16, wherein the ratio of synthetic and natural rubber is between about 3:1 to about 1:3, more specifically between about 2:1 to about 1:2 and in particular between about 1.5:1 to about 1:1.5.

19. The shaver handle according to any preceding aspect, wherein the rubber particles comprise poly-cis-isoprene, styrene-butadiene rubber, copolymer of isobutylene with isoprene (butyl rubber), polyisoprene, chloroprene or nitrile rubber, or mixtures thereof.

20. The shaver handle according to any preceding aspect, wherein the rubber particles comprise poly-cis-isoprene and styrene-butadiene rubber.

21. The shaver handle according to any preceding aspect, wherein the rubber particles comprise styrene-butadiene rubber.

22. The shaver handle according to any preceding aspect, wherein the carbon black has an average particle size of between about 10 nm to about 45 nm, more specifically between about 15 nm to about 40 nm and in particular between about 20 nm to about 35 nm.

23. The shaver handle according to any preceding aspect, wherein the rubber particles comprise fillers, in particular silica, chalk or mixtures thereof.

24. The shaver handle according to aspect 23, wherein the rubber particles comprise between about 5 wt.-% and about 50 wt.-%, more specifically between about 10 wt.-% and about 40 wt.-% and in particular between about 20 wt.-% and about 35 wt.-% of a mixture of fillers and carbon black, relative to the total weight of the rubber particles.

25. The shaver handle according to any preceding aspect, wherein the shaver rubber particles comprise vulcanization agents, in particular sulfur and/or zinc oxide.

26. The shaver handle according to aspect 25, wherein the rubber particles comprise between about 1 wt.-% and about 10 wt.-%, more specifically between about 2 wt.-% and about 8 wt.-% and in particular between about 3 wt.-% and about 7 wt.-% of vulcanization agents, relative to the total weight of the rubber particles.

27. The shaver handle according to any preceding aspect, wherein the rubber particles comprise plasticizers.

28. The shaver handle according to aspect 27, wherein the rubber particles comprise between about 5 wt.-% and about 20 wt.-%, more specifically between about 7 wt.-% and about 18 wt.-% and in particular between about 10 wt.-% and about 15 wt.-% of plasticizers, relative to the total weight of the rubber particles.

29. The shaver handle according to any preceding aspect, wherein the rubber particles comprise antioxidants and antiozonants.

30. The shaver handle according to aspect 29, wherein the rubber particles comprise between about 0.1 wt.-% and about 5 wt.-%, more specifically between about 0.5 wt.-% and about 3 wt.-% and in particular between about 0.8 wt.-% and about 2.0 wt.-% of a mixture of antioxidants and antiozonants, relative to the total weight of the rubber particles.

31. The shaver handle according to any preceding aspect, wherein the coefficient of friction of the first material in dry condition is between about 0.45 mN and about 0.7 mN, more specifically between about 0.5 mN and about 0.65 mN and in particular between about 0.54 mN and about 0.6 mN.

32. The shaver handle according to any preceding aspect, wherein the coefficient of friction of the first material in wet condition is between about 0.5 mN and about 1.1 mN, more specifically between about 0.55 mN and about 1.05 mN and in particular between about 0.6 mN and about 1.0 mN.

33. The shaver handle according to any preceding aspect, wherein the second material comprises a second polymer.

34. The shaver handle according to aspect 33, wherein the second material comprises a thermoplastic polymer, more specifically a polyolefin and in particular a polypropylene.

35. The shaver handle according to aspects 33 or 34, wherein the second material comprises a filler, in particular CaCO₃ and/or talc.

36. The shaver handle according to aspect 35, wherein the second material comprises between about 5 wt.-% to about 40 wt.-%, more specifically between about 10 wt.-% to about 35 wt.-% and in particular between about 15 wt. % to about 30 wt. % of the filler or mixture of fillers, relative to the total weight of the polymer.

37. The shaver handle according to any preceding aspect, wherein the shaver handle comprises an odor scavenger and/or a fragrance.

38. A process for manufacturing a shaver handle according to any preceding aspect, wherein the process comprises:

injection molding or extruding a blank comprising the second material, and overmolding the blank with the first material.

39. A process for manufacturing a shaver handle according to any preceding aspect, wherein the process comprises:

co-extruding the first and second material such that the second material forms an inner body and the first material at least partially encloses the inner body.

40. The process for manufacturing a shaver handle according to aspect 38 or 39, wherein the first material comprises a first polymer and rubber particles, wherein the rubber particles comprise carbon black.

41. The process according to aspect 40, wherein the rubber particles are recycled from tires, in particular recycled from automotive tires.

1. A shaver handle, wherein at least part of a surface of the shaver handle comprises a first material, wherein the first material comprises a first polymer and rubber particles, wherein the rubber particles comprise carbon black and wherein a core of the shaver handle comprises a second material.

2. The shaver handle according to claim 1, wherein the rubber particles comprise devulcanized rubber particles.

3-17. (canceled)

18. The shaver handle according to claim 1, wherein the rubber particles comprise surface-devulcanized rubber particles.

19. The shaver handle according to claim 1, wherein a surface layer of the rubber particles comprises functional groups.

20. The shaver handle according to claim 19, wherein the functional groups comprises hydroxyl-groups, epoxy-groups, thiol-groups and/or carboxyl-groups.

21. The shaver handle according to claim 1, wherein the first polymer is a thermoplastic elastomer.

22. The shaver handle according to claim 21, wherein the thermoplastic elastomer is a styrenic block copolymer.

23. The shaver handle according to claim 1, wherein the first material comprises between about 5 wt.-% and about 60 wt.-% of the rubber particles, relative to a total weight of the first material.

24. The shaver handle according to claim 1, wherein the first material comprises between about 40 wt.-% and about 90 wt.-% first polymer, relative to a total weight of the first material.

25. The shaver handle according to claim 1, wherein the rubber particles are recycled from tires.

26. The shaver handle according to claim 1, wherein the rubber particles comprise natural and/or synthetic rubber.

27. The shaver handle according to claim 1, wherein the rubber particles comprise poly-cis-isoprene, styrene-butadiene rubber, copolymer of isobutylene with isoprene (butyl rubber), polyisoprene, chloroprene or nitrile rubber, or mixtures thereof.

28. The shaver handle according to claim 1, wherein the rubber particles comprise fillers.

29. The shaver handle according to claim 1, wherein the second material comprises a second polymer.

30. The shaver handle according to claim 29, wherein the second material comprises a thermoplastic polymer.

31. The shaver handle according to claim 30, wherein the thermoplastic polymer comprises a polyolefin.

32. A process for manufacturing a shaver handle according to claim 1, wherein the process comprises:
injection molding or extruding a blank comprising the second material, and overmolding the blank with the first material.

33. A process for manufacturing a shaver handle according to claim 1, wherein the process comprises:
co-extruding the first and second material such that the second material forms an inner body and the first material at least partially encloses the inner body.

34. The process for manufacturing a shaver handle according to claim 33, wherein the first material comprises a first polymer and rubber particles, wherein the rubber particles comprise carbon black.

35. The process according to claim 34, wherein the rubber particles are recycled from tires.
